(19) United States
(12) Patent Application Publication
(10) Pub. No.: US 2013/0212138 A1
(43) Pub. Date: Aug. 15, 2013

(54) CURVE REPRESENTATIONS

(71) Applicants: Eyal Ofek, Redmond, WA (US); Brian Beckman, Newcastle, WA (US)

(72) Inventors: Eyal Ofek, Redmond, WA (US); Brian Beckman, Newcastle, WA (US)

(73) Assignee: Microsoft Corporation, Redmond, WA (US)

(21) Appl. No.: 13/371,800

(22) Filed: Feb. 13, 2012

(51) Int. Cl. G06F 17/10

(52) U.S. Cl. 708/200

(57) ABSTRACT

Among other things, one or more techniques and/or systems are provided for creating a hierarchical multi-resolution representation of a curve. That is, a first-level curve (e.g., a relatively lower resolution of the curve) may be represented as a set of points within a first-level curve representation. A non-first-level curve (e.g., a second-level curve associated with a relatively higher resolution of the curve) may be represented as a set of offsets from the first-level curve (e.g., distances along offsets vectors starting from the first-level curve to the second-level curve), which is more efficient than storing complete data sets for different resolutions of the curve. In this way, various resolutions of the curve may be efficiently represented within the hierarchical multi-resolution representation. The various resolutions (e.g., levels) of the curve may also be acted upon or manipulated independently of one another.

### BACKGROUND

Today, many services and applications provide functionality associated with image data and/or drawing data. For example, an online mapping service may provide an interactive map within a web user interface to a user (e.g., the interactive map may illustrate a neighborhood located along a shoreline based upon imaging data provided by a survey company). The user may zoom into a particular area of the interactive map to see more details about a portion of the map (e.g., the zoomed-in view may depict the user's personal residence along the shoreline). The user may edit the interactive map by inputting drawing modifications (e.g., the user may draw a new garage near the user's personal residence). In this way, the online mapping service may generate updated mapping data comprising the drawing modifications. Unfortunately, a subsequently provided update to the imaging data provided by the survey company (used by the online mapping service to create interactive maps) may overwrite the updated mapping data comprising the drawing modifications by the user. For example, the survey company may provide a new set of imaging data to the online mapping service (e.g., a new survey may have been conducted) which may supplant the drawing modifications provided by the user (e.g., such that the user's garage may not be seen in a resulting image).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for representing an N level curve from an N−1 level curve, and/or for creating a hierarchical multi-resolution representation of a curve are disclosed herein. A curve may correspond to a wide variety of image/drawing data, such as a line, a shape, an object, a drawing, an image, etc. (e.g., a curved line, a drawing of a house and road, an image of a shoreline, a closed contour curve, an open curve, a sequential set of points in a k-dimensional set, etc.). The curve may be associated with one or more resolutions (e.g., a first-level curve may represent a relatively low resolution of the curve, a second-level curve may represent a relatively medium resolution of the curve, a third-level curve may represent a relatively high resolution of the curve, etc.). Accordingly, it may be advantageous to represent one or more resolutions of the curve within a hierarchical multi-resolution representation comprising one or more level curve representations (e.g., an N−1 level curve representation representing an N−1 level curve, an N level curve representation representing an N level curve, an N+1 level curve representation representing an N+1 level curve, etc.). In this way, the curve may be rendered based upon one or more level curve representations (e.g., a smooth portion of a curve (e.g., 1 pixel=1 meter) may be represented based upon a first-level curve and a second-level curve, while another portion of the curve (e.g., 1 pixel=2 meters) may be represented based upon the first-level curve, the second-level curve, and a third-level curve, and so on, etc.). Such curves may be represented within a hierarchical multi-resolution representation (e.g., where a basis internal representation may be a Laplasian curve where respective pieces of information are stored once at a corresponding resolution and/or frequency level, which may, for example, inhibit duplication of information and/or generation of inconsistencies).

In one example, an N−1 level curve may represent a first resolution of a curve that is relatively lower than a second resolution of the curve represented by the N level curve (e.g., the N−1 level curve may comprise a low resolution illustration of a neighborhood along a shoreline, while the N level curve may comprise a relatively higher resolution illustration of the neighborhood along the shoreline with a detailed drawing of a house and garage). In one example of representing the N level curve from the N−1 level curve, a set of offset vectors may be computed from the N−1 level curve to the N level curve. For example, the set of offset vectors may comprise normal vectors starting along the N−1 level curve (e.g., at known points/positions and/or inferred points/positions) and ending along the N level curve. A set of offsets may be derived from the set of offset vectors (e.g., an offset vector may specify a direction in k-dimensional space). That is, an offset may comprise a distance along an offset vector from the N−1 level curve to the N level curve (e.g., the offset may comprise a number). An N level curve representation comprising the set of offsets representing the N level curve may be created. The N level curve representation may be dependent upon the N−1 level curve because the set of offsets may be based upon points or offsets along the N−1 level curve. For example, if the N−1 level curve is modified, such as a change in location of a shoreline, then the N level curve may become dependent upon the updated N−1 level curve (e.g., the house and garage may be offset by the same amount from the new location of the shoreline). In this way, the N level curve may be constructed/rendered by interpolating the set of offsets within the N level curve representation as applied to the N−1 level curve because the N level curve is defined relative to the N−1 level curve (e.g., rather than relative to the map/screen/world) and/or may have higher (e.g., additional) details than the N−1 level curve.

A hierarchical multi-resolution representation of the curve comprising one or more level curve representations may be created. For example, the hierarchical multi-resolution representation may comprise a first-level curve representation comprising a set of points defining a first-level curve, a second-level curve representation comprising a set of offsets dependent upon the first-level curve, a third-level curve representation comprising a second set of offsets dependent upon the second-level curve, etc. (e.g., the N−1 level curve may comprise the first-level curve, the N level curve may comprise the second-level curve, the N+1 level curve may comprise the third-level curve, etc.). Because respective level curves may be represented by individual level curve representations (e.g., as opposed to all level curves represented as a single representation), an update to a particular level curve may not overwrite other level curves (e.g., if a first-level curve comprising a low resolution illustration of a shoreline is updated with a modified location of the shoreline, then a second-level curve comprising a relatively higher resolution of a house along the shoreline may not be overwritten, but may merely depend upon the updated first-level curve). Additionally, a filter (e.g., a smoother, an interpolation scheme, and/or other filters) may be selectively applied to one or more level curve representations within the hierarchical multi-resolution representation without being applied to non-selected level curve representations (e.g., anti-aliasing and/or splining may be performed upon a relatively high resolution fifth level curve by applying a low pass filter to merely a fifth level curve representation). For example, a filter may be applied to the N level curve by executing a one-dimensional filtering technique upon the set of offsets within the N level curve representation without affecting the N−1 level curve (e.g., a Fourier transform, a band-pass filter, and/or other filtering algorithms may be executed).

The curve may be rendered utilizing one or more level curves represented within the hierarchical multi-resolution representation of the curve. That is, the one or more level curves may be selected based upon a rendering resolution at which the curve is to be rendered. For example, a relatively high resolution fourth-level curve may be rendered as the curve based upon a zoom-in operation corresponding to a relatively high rendering resolution. The fourth-level curve may be rendered by applying a set of offsets within a fourth-level curve representation to a rendered third-level curve, for example.

A first hierarchical multi-resolution representation may be fused with a second hierarchical multi-resolution representation (e.g., a first N level curve may be fused with a second N level curve to create a fused N level curve). In one example, a first set of offsets within a first N level curve representation may be averaged (e.g., a weighted average based upon one or more factors, such as reliability of a source associated with a set of offsets) with a second set of offsets within a second N level curve representation to create a fused N level curve representation of a fused N level curve (e.g., a first N level curve representation comprising offsets associated with an illustration of a neighborhood by a first user at a medium resolution may be fused with a second N level curve representation comprising offsets associated with an illustration of the neighborhood by a second user at the medium resolution). The fused N level curve representation may comprise a fused set of offsets. In one example, a first set of offset vectors associated with the first N level curve may be reconciled (e.g., brought together, merged, averaged, etc.) with a second set of offset vectors associated with the second N level curve to create a fused set of offset vectors for the fused N level curve. The fused N level curve may be constructed/rendered by, for example, interpolating, aggregating, and/or averaging, etc. the set of fused offsets within the fused N level curve representation as applied to the N−1 level curve (e.g., and/or as applied to a fused N−1 level curve if a fusion occurred between a first N−1 level curve and a second N−1 level curve to crate the fused N−1 level curve).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of representing an N level curve from an N−1 level curve.

FIG. 2 is a flow chart illustrating an exemplary method of creating a hierarchical multi-resolution representation of a curve.

FIG. 3 is a component block diagram illustrating an exemplary system for representing an N level curve from an N−1 level curve.

FIG. 4 is an illustration of an example of a first-level curve and a second-level curve.

FIG. 5 is an illustration of an example of rendering a curve based upon one or more level curves.

FIG. 6 is an illustration of an example of rendering a curve based upon an updated first-level curve.

FIG. 7 is an illustration of an example of fusing a first N−1 level curve representation and a second N−1 level curve representation.

FIG. 8 is an illustration of an example of fusing a first N level curve representation and a second N level curve representation.

FIG. 9 is an illustration of an example of updating a first-level curve representation based upon a modification to a first-level curve.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many applications allow users to upload, edit, contribute to, and/or interact with image data and/or drawing data, such as an interactive map, image, drawing, etc. For example, an online mapping service may allow users to view, contribute to, and/or interact with interactive maps (e.g., a survey company may provide relatively lower resolution image data for a map, while individual users may provide relatively higher resolution drawing data for the map). Because the online mapping service may store the interactive map as a single entity, updates by a user may potentially overwrite prior details provided by other users. In one example, first user may contribute drawing data depicting a neighborhood road near a shoreline at a relatively medium resolution. A second user may contribute drawing data depicting a new lamppost along the neighborhood road at a relatively higher resolution. The contributions of the first and second user may be saved within a single mapping entity. If the first user updates a location and curvature of the neighborhood road, then the single mapping entity may be updated. However, if a discrepancy exists between details of the updated location and curvature of the neighborhood road and details of the new lamppost, then one of the details may be overwritten within the single mapping entity (e.g., details of a user with a higher credibility may overwrite details of users with lower credibility; relatively newer details may overwrite relatively older details; etc.).

Accordingly, one or more systems and/or techniques for representing an N level curve from an N−1 level curve, and/or creating a hierarchical multi-resolution representation of a curve are provided herein. It may be appreciated that representing curves as provided herein allows edits to be made to the curves while mitigating loss of underlying data. A curve may correspond to image/drawing data, such as a line, a shape, an object, a drawing, and image, etc. The curve may be associated with one or more resolutions (e.g., a low resolution of a curve may illustrate a shoreline and an outline of a house, while a high resolution of the curve may illustrate the shoreline, the house, and additional details of the house). It may be advantageous to represent the curve as one or more level curve representations corresponding to various resolutions of the curve. A first-level curve of the curve may be represented as a set/sequence of points, while non-first-level curves of the curve may be represented as a set of offsets from a lower-level curve (e.g., a fourth-level curve representation of a fourth-level curve may comprise a set of offsets, where an offset may comprise a distance from a third-level curve to the fourth-level curve along an offset vector). In this way, a hierarchical multi-resolution representation of the curve comprising one or more level curve representations may be created. The first-level curve may be rendered based upon the set of points (e.g., one or more interpolation techniques may be performed upon the set of points to construct the first-level curve). A non-first-level curve may be constructed/rendered by interpolating a set of offsets, within a non-first-level curve representation, as applied to a lower-level curve (e.g., a fourth-level curve may be constructed by applying a set of offsets within a fourth-level curve representation to a third-level curve).

It may be appreciated that in one example, N may correspond to a resolution level of a curve (e.g., an (N−2=first) level curve may correspond to a relatively low resolution of a curve; an (N−1=second) level curve may correspond to a relatively medium resolution of the curve; an (N=third) level curve may correspond to a relatively higher resolution of the curve; etc.). In this way, an N−1 level curve may correspond to a first resolution lower than a second resolution of an N level curve (e.g., the N−1 level curve may comprise relatively less detail than the N level curve). It may be appreciated that the examples provided herein may describe an N level curve as a non-first-level curve that may be represented by a set of offsets within an N level curve representation. It may be appreciated that the examples provided herein may describe an N−1 level curve as a first-level curve that may be represented by a set of points within an N−1 level curve representation and/or a non-first-level curve that may be represented by a set of offsets within an N−1 level curve representation.

It may be appreciated that in one example, a curve may be defined as a finite ordered sequence of known points (e.g., vertices) and line segments between such known points (e.g., a polyline and/or a spline). Along the curve, additional/inferred points may exist, such as intermediate and/or interstitial points between vertices that may be obtained by interpolation, for example. A second level curve may be represented as a set of offsets (e.g., within a second level curve representation). An offset may correspond to a number representing a distance along an offset vector anchored to the first level curve. An offset vector may comprise a direction in k-dimensional space, and may be anchored along the first level curve. Because the second level curve may correspond to a higher level of detail (e.g., additional vertices than the first level curve) relative to the first level curve, the set of offsets may be derived from known points along the first level curve and from inferred points along the first level curve (e.g., intermediate and/or interstitial points between vertices). In this way, the second level curve may be represented by the set of offsets corresponding to offset vectors anchored at known points and/or inferred points along the first level curve. It may be appreciated that additional curves may be represented in such a manner (e.g., a third level curve may be represented by offsets corresponding to offset vectors anchored at known positions and/or inferred positions along the second level curve that may have been translated from the set of offsets within the second level curve representation). It may be appreciated that known positions and/or inferred positions, as used herein, may correspond to points along a non-first level curve that may have been translated from one or more offsets defining the non-first level curve (e.g., offsets within a non-first level curve representation).

In one example, a user may utilize a cell phone (e.g., GPS, gyroscope, accelerometer, etc.) to create a drawing that models a walking route traversed by the user through a forest. The gyroscope and accelerometer of the cell phone may provide relatively high accuracy measurements of local turns (e.g., up to 10 meters), but may provide relatively low accuracy measurements for global turns (e.g., starting around 30 meters). In contrast, the GPS may provide relatively low accuracy measurements of local turns, but may provide relatively high accuracy measurements for global turns. Accordingly, the GPS may be used to generate a low resolution base curve (e.g., a first-level curve represented by a first-level curve representation comprising points along the walking route), while the gyroscope and/or accelerometer may be used to generate offsets from the low resolution base curve (e.g., a second-level curve represented by a second-level curve representation comprising offsets from the first-level curve).

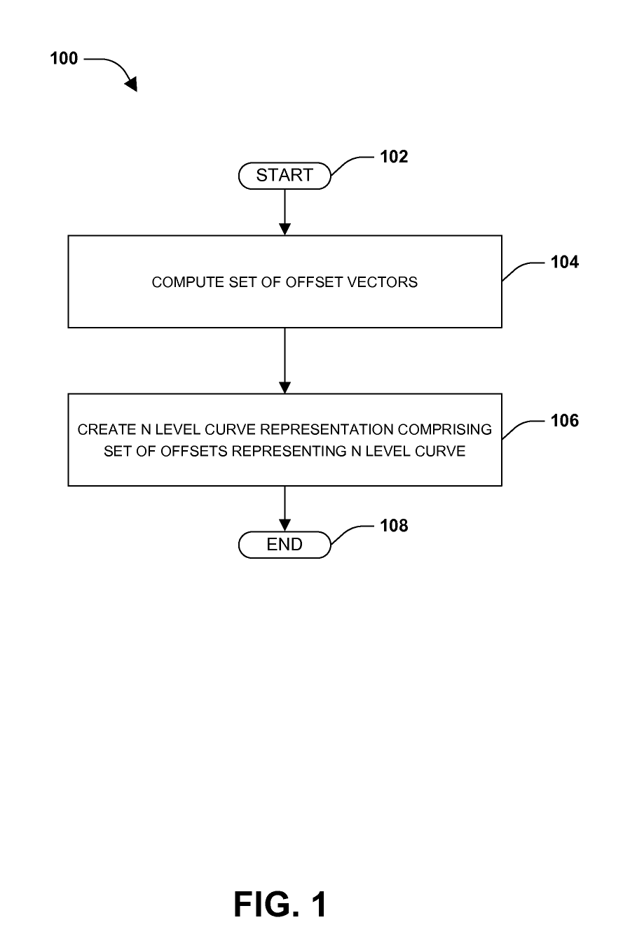

One embodiment of representing an N level curve from an N−1 level curve is illustrated by an exemplary method 100 in FIG. 1. At 102, the method starts. At 104, a set of offset vectors from the N−1 level curve to the N level curve may be computed. In one example where the N−1 level curve is a first-level curve (e.g., a lowest resolution curve), a set of points may be known for the N−1 level curve (e.g., as defined within an N−1 level curve representation). The first-level curve may, for example, be constructed by interpolating the set of points (e.g., linear interpolation). It may be appreciated that a variety of interpolation techniques may be selectively performed to construct the first-level curve. Accordingly, a first set of offset vectors (e.g., a first set of normal vectors) may be computed from known points (e.g., vertices defining the N−1 level curve) along the N−1 level curve that are defined within the set of points comprised within the N−1 level curve representation. A second set of offset vectors (e.g., a second set of normal vectors) may be computed from inferred points along the N−1 level curve (e.g., inferred points may be identified by one or more interpolation techniques). For example, inferred points may correspond to intermediate and/or interstitial points along the N−1 level curve that are between known points, such as vertices defining the N−1 level curve. In this way, the set of offset vectors (from the N−1 level curve to the N level curve) may be based upon at least some of the first set of offset vectors (computed from known offsets defining the N−1 level curve) and/or at least some of the second set of offset vectors (computed from inferred offsets defining the N−1 level curve). It may be appreciated that a variety of vector computation techniques may be utilized in creating the set of offset vectors, such as one or more normal vector computation techniques (e.g., a user may select a particular offset vector computation technique).

In another example where the N−1 level curve is a non-first-level curve (e.g., a non-lowest resolution curve), offsets defining the N−1 level curve may be known (e.g., an N−1 level curve representation may define a set of offsets from an N−2 level curve to the N−1 level curve). The non-first-level curve may, for example, be constructed by interpolating the set of offsets defining the N−1 level curve (e.g., linear interpolation). It may be appreciated that a variety of interpolation techniques may be selectively performed to construct the non-first-level curve. Accordingly, a first set of offset vectors (e.g., a first set of normal vectors) may be computed from known positions along the N−1 level curve that may have been translated from offsets within the N−1 level curve representation. A second set of offset vectors (e.g., a second set of normal vectors) may be computed from inferred positions along the N−1 level curve that may have been translated from offsets within the N−1 level curve representation (e.g., the offsets may have been interpolated to construct the N−1 level curve defined by a set of known positions (e.g., vertices), such that a set of inferred positions may be identifiable along the N−1 level curve (e.g., intermediate and/or interstitial positions between the known positions/vertices)). In this way, the set of offset vectors (from the N−1 level curve to the N level curve) may be based upon at least some of the first set of offset vectors (computed from known positions defining the N−1 level curve) and/or at least some of the second set of offset vectors (computed from inferred positions along the N−1 level curve). It may be appreciated that a variety of vector computation techniques may be utilized in creating the set of offset vectors, such as one or more normal vector computation techniques (e.g., a user may select a particular offset vector computation technique).

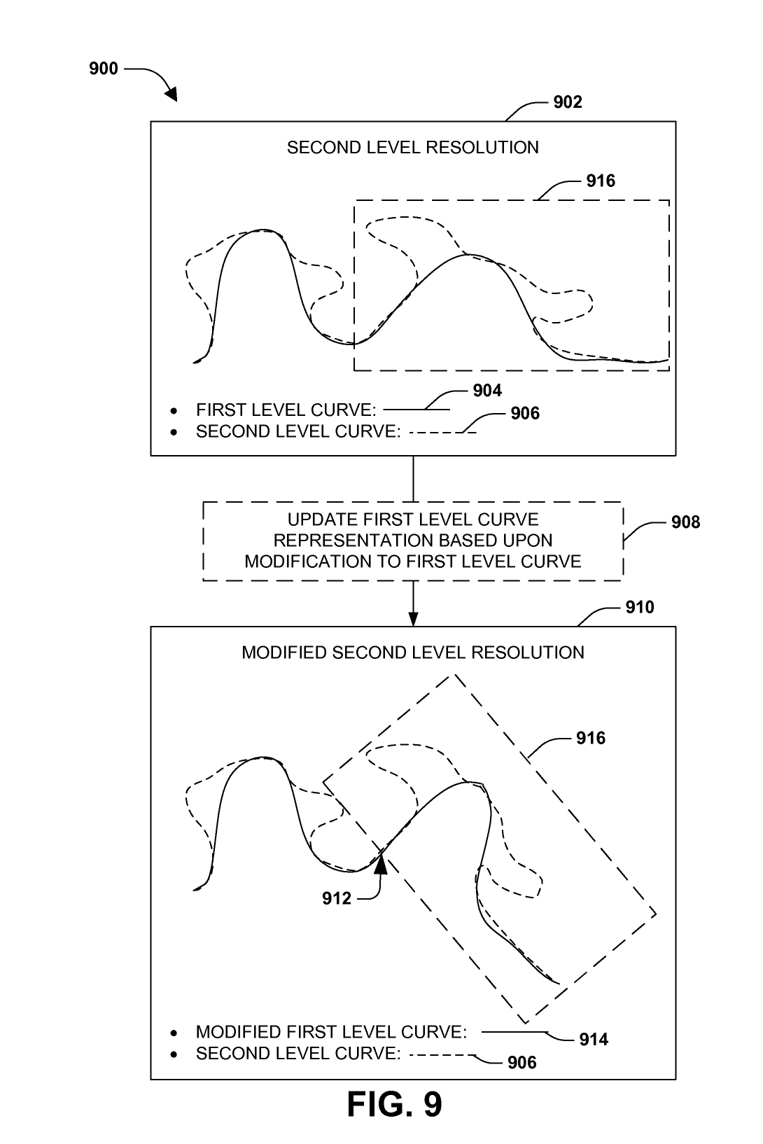

At 106, an N level curve representation comprising a set of offsets representing the N level curve may be created. An offset within the set of offsets may comprise a distance (e.g., a number) along an offset vector (e.g., a direction in k-dimensional space) from the N−1 level curve to the N level curve. In this way, given the N−1 level curve, the N level curve may be constructed/rendered. For example, for respective offsets within the set of offsets, an offset vector starting from the N−1 level curve may be traveled for a distance specified by an offset, such that the end of the offset vector corresponds to a position along the N level curve. In this way, a set of positions along the N level curve may be determined by traveling along offset vectors for distances specified by offsets within the set of offsets. In constructing the N−1 level curve, interpolation, for example, may be performed upon the set of positions along the N−1 level curve in one example. It may be appreciated that, although generally not the case, the N level curve may be constructed by merely using the offsets within the N level curve representation that are anchored at known points/positions along the N−1 level curve (e.g., offsets that are anchored at inferred points/positions along the N−1 level curve may not be used because such inferred points/positions do not define the N−1 level curve, but are merely additional inferred points/positions). It may be appreciated that in one example, the N level curve may be dependent upon the N−1 level curve in that the set of offsets within the N level curve representation are offsets along offset vectors starting along the N−1 level curve. In one example, the N−1 level curve may be modified (e.g., a survey company may update a location of a shoreline depicted within the N−1 level curve). The N−1 level curve representation may be updated based upon the modification (e.g., a set of points within the N−1 level curve representation may be updated to represent the new location of the shoreline). Accordingly, the N level curve may now depend upon the updated N−1 level curve (e.g., see FIG. 9 for an illustrative example of an N level curve depending upon an updated N−1 level curve). That is, the set of offsets within the N level curve representation may retain similar values, but may now depend upon the updated N−1 level curve as represented by the updated N−1 level curve representation (e.g., the N level curve may represent a house along the shoreline, which may now be depicted/located along the new location of the shoreline because the offsets representing the house may now be offsets from the updated shoreline location). It may be appreciated that in one example, updating the N−1 level curve representation may not overwrite and/or modify the N level curve representation (e.g., updates to the shoreline depicted with the updated N−1 level curve representation may not overwrite the house depicted within the N level curve representation), thus preserving the details depicted within the N level curve and/or other curves.

In one example, an N+1 level curve representation of an N+1 level curve may be created based upon the N level curve representation. A second set of offsets from the N level curve to the N+1 level curve may be computed based upon known positions along the N level curve that may have been translated from the set of offsets within the N level curve representation (e.g., the set of offsets may have been interpolated to identify the known positions) and/or based upon inferred positions along the N level curve translated from the set of offsets within the N level curve representation (e.g., the set of offsets may have been interpolated to identify the known positions, such that inferred positions may be identifiable along the N level curve (e.g., intermediate and/or interstitial positions between the known positions). The N+1 level curve representation may be created to comprise the second set of offsets representing the N+1 level curve. An offset within the second set of offsets may comprise a distance along an offset vector within the second set of offsets from the N level curve to the N+1 level curve. In this way, given the N level curve, the N+1 level curve may be constructed by interpolating the second set of offsets within the N+1 level curve representation as applied to the N level curve. Similarly, given the N+1 level curve, the N level curve may be constructed using the second set of offsets within the N+1 level curve representation to identify positions along the N level curve that may be interpolated to construct/render the N level curve.

It may be appreciated that a curve may be represented by a plurality of level curves at various resolutions. Accordingly, a hierarchical multi-resolution representation of the curve may be created. The hierarchical multi-resolution representation may comprise one or more level curve representations (e.g., a first-level curve representation may represent a first-level curve corresponding to a first resolution, such as a lowest resolution, of the curve; a second-level curve representation may represent a second-level curve corresponding to a second resolution, such as a relatively higher resolution, of the curve; etc.). For example, a first-level curve may be represented by a first-level curve representation comprising a set of points defining the first-level curve (e.g., the first-level curve may be constructed by interpolating between the set of points). A non-first-level curve (e.g., a second-level curve) may be represented as a non-first-level curve representation comprising a set of offsets defining the non-first-level curve (e.g., the non-first-level curve may be constructed by interpolating between the set of offsets). In this way, the hierarchical multi-resolution representation may be created.

It may be appreciated that in one example, a first hierarchical multi-resolution representation of a curve and a second hierarchical multi-resolution representation of the curve may be fused together. For example, a first N level curve representation within the first hierarchical multi-resolution representation may be fused with a second N level curve representation within the second hierarchical multi-resolution representation. That is, a first set of offsets within the first N level curve representation may be averaged (e.g., a weighted average may be calculated based upon one or more factors, such as reliability of a source associated with a set of offsets) with a second set of offsets within the second N level curve representation to create a fused N level curve representation of a fused N level curve comprising a fused set of offsets. In one example, a first set of offset vectors associated with the first N level curve may be reconciled (e.g., brought together, merged, averaged, etc.) with a second set of offset vectors associated with the second N level curve to create a fused set of offset vectors for the fused N level curve. The fused set of offsets may be associated with the fused set of offset vectors for the fused N level curve.

In one example of fusing two N−1 level curve representations where an N−1 level curve is a first-level curve, a first set of points within a first N−1 level curve representation may be averaged (e.g., weighted average) with a second set of points within a second N−1 level curve representation to create a fused N−1 level curve representation of a fused N−1 level curve comprising a fused set of points. It may be appreciated that the fused N level curve representation may be dependent upon the fused N−1 level curve representation (e.g., the fused N level curve representation may comprise a fused set of offsets, where a fused offset may be a distance along an offset vector starting along the fused N−1 level curve). In one example, a first set of offset vectors associated with the first N−1 level curve may be reconciled (e.g., brought together, merged, averaged, etc.) with a second set of offset vectors associated with the second N−1 level curve to create a fused set of offset vectors for the fused N−1 level curve. The fused set of points may be associated with the fused set of offset vectors for the fused N−1 level curve.

In one example of fusing two N−1 level curve representations where an N−1 level curve is a non-first-level curve, a first set of offsets within a first N−1 level curve representation may be averaged (e.g., weighted average) with a second set of offsets within a second N−1 level curve representation to create a fused N−1 level curve representation of a fused N−1 level curve comprising a fused set of offsets. It may be appreciated that the fused N level curve representation may be dependent upon the fused N−1 level curve representation (e.g., the fused N level curve representation may comprise a fused set of offsets, where a fused offset may be a distance along an offset vector starting along the fused N−1 level curve). In one example, a first set of offset vectors associated with the first N−1 level curve may be reconciled (e.g., brought together, merged, averaged, etc.) with a second set of offset vectors associated with the second N−1 level curve to create a fused set of offset vectors for the fused N−1 level curve. The fused set of offsets may be associated with the fused set of offset vectors for the fused N−1 level curve.

A curve may be rendered (e.g., within a map editing interface) using one or more level curves within the hierarchical multi-resolution representation of the curve. For example, a user may zoom into a particular rendering resolution of a map using the map editing interface. The rendering resolution may correspond to a fourth-level curve. Accordingly, one or more level curve representations, such as a fourth-level curve representation, may be used to render the curve within the map at the rendering resolution. In this way, a particular amount of detail appropriate for the rendering resolution may be provided by the one or more level curve representations. It may be appreciated that other functionality may be provided for the curve, such as filtering. For example, one or more filters may be applied to one or more level curves within the hierarchical multi-resolution representation (e.g., a filter for smoothing may be applied to merely the fourth-level curve, but not other level curves). In this way, a curve may be represented by various level curves that may be dependent upon one another and/or functionality may be selectively applied to particular level curves. At 108, the method ends.

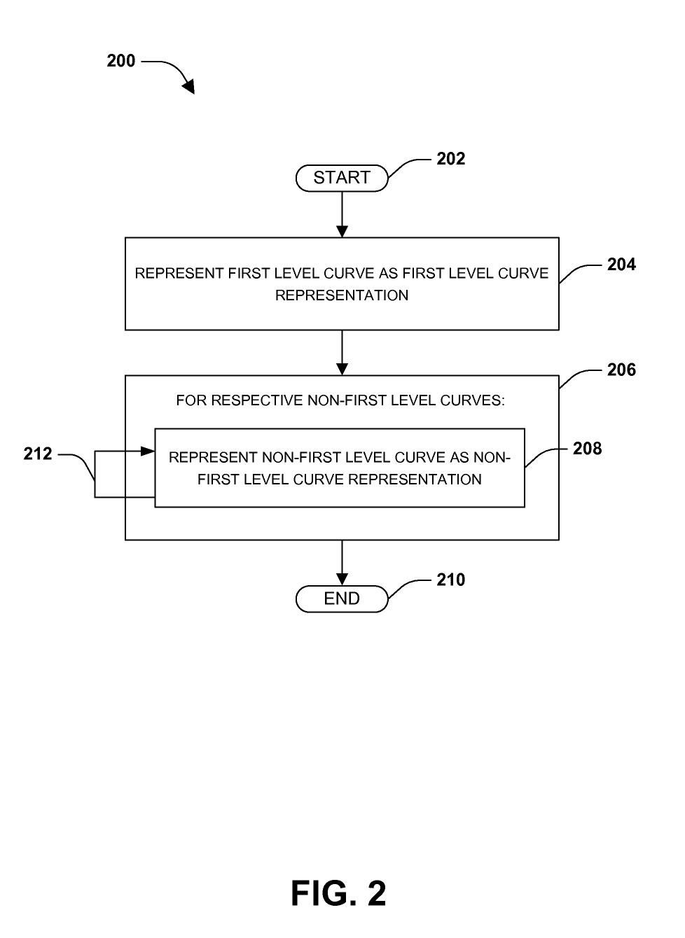

One embodiment of creating a hierarchical multi-resolution representation of a curve is illustrated by an exemplary method 200 in FIG. 2. At 202, the method starts. At 204, a first-level curve may be represented as a first-level curve representation within the hierarchical multi-resolution representation of the curve (e.g., the first-level curve may represent a lowest resolution of the curve, such as a set of points roughly illustrating a shoreline from a zoomed out view provided by a surveying service). The first-level curve representation may comprise a set of points defining the first-level curve (e.g., the set of points may be interpolated to construct the first-level curve). It may be appreciated that one or more non-first-level curves may be associated with the curve at various resolutions (e.g., a first user may zoom into a map illustrating the shoreline, and may draw a house at a relatively higher resolution of details than the shoreline, which may be represented as a second-level curve; a second user may zoom into the map illustrating the shoreline and house, and may draw additional details for the house at a relatively higher resolution of details than the house and the shoreline, which may be represented as a third-level curve).lower-level

At 206, for respective non-first-level curves, a non-first-level curve may be represented as a non-first-level curve representation within the hierarchical multi-resolution representation of the curve, at 208. The non-first-level curve representation may comprise a set of offsets dependent upon a lower-level curve representation. An offset may comprise a distance along an offset vector from the lower-level curve representation to the non-first-level curve. For example, a second-level curve representation may comprise offsets along offset vectors starting along the first-level curve. It may be appreciated that one or more non-first-level curves may be represented within the hierarchical multi-resolution representation by iterating over 206, at 212, and representing such non-first-level curves as non-first level curve representations within the hierarchical multi-resolution representation (e.g., an N+1 level curve may be represented as an N+1 level curve representation comprising a second set of offsets from the N level curve along offset vectors anchored along inferred positions and/or known positions along the N level curve). In this way, one or more resolutions of the curve may be represented by one or more level curve representations within the hierarchical multi-resolution representation. It may be appreciated that edits to one or more of the level curves may be propagated to one or more level curve representations within the hierarchical multi-resolution representation. In one example, an edit to the N level curve may be propagated to the N level curve representation and/or the N−1 level curve representation because the N−1 level curve represents a scaled down version of the N level curve at a relatively lower resolution. In another example, an edit to the N−1 level curve may result in a modified N−1 level curve representation from which the N level curve may depend. At 210, the method ends.

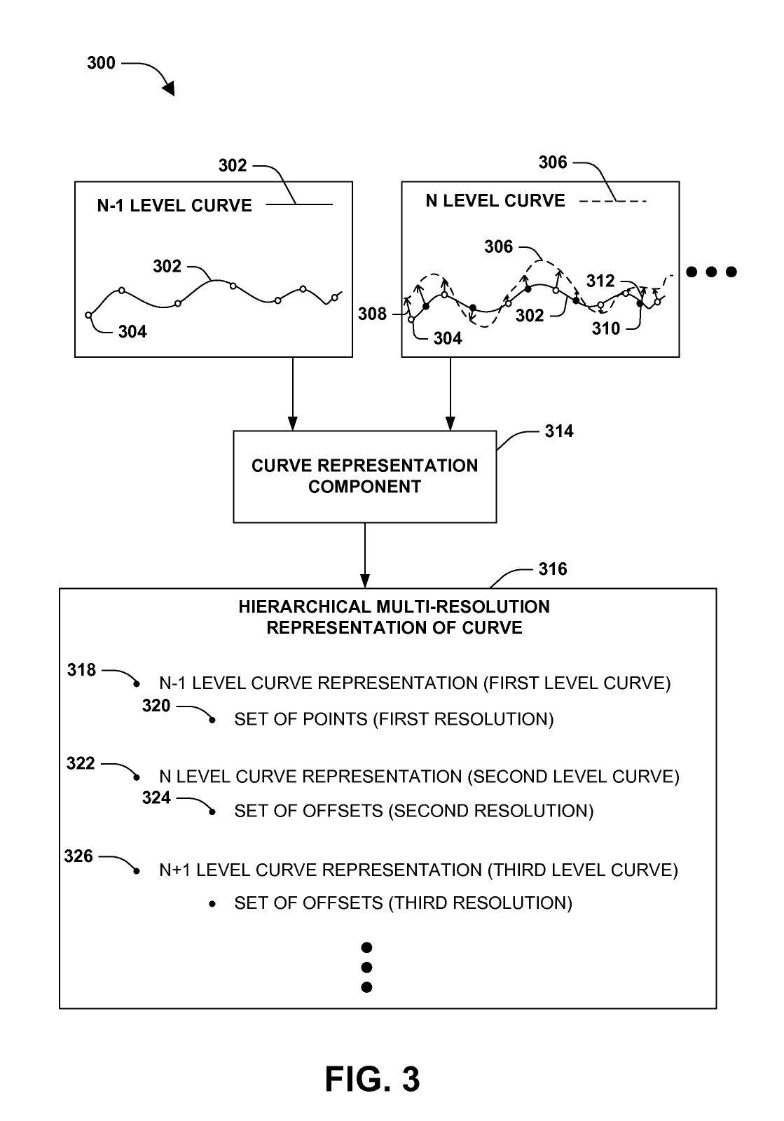

FIG. 3 illustrates an example of a system 300 configured for representing an N level curve 306 from an N−1 level curve 302. In one example, the N−1 level curve 302 may represent a first resolution of a curve. The N level curve 306 may represent a second resolution of the curve that is at a higher resolution (e.g., higher level of detail) than the first resolution. In this way, the curve may be represented by one or more level curves corresponding to various resolutions of the curve. It may be advantageous to represent the N level curve 306 as a set of offsets from the N−1 level curve 302 (e.g., as opposed to storing points along the N level curve 306). That is, an N level curve representation 322 may comprise a set of offsets 324 that may depend upon the N−1 level curve 302 (e.g., an offset may be a distance along an offset vector starting along the N−1 level curve 302). Thus, updates to the N−1 level curve 302 may not overwrite the N level curve 306 (e.g., modifications to a lower resolution representation of the curve may not overwrite higher level details of a higher resolution representation of the curve). Additionally, the updates to the N−1 level curve 302 may be “propagated” to the N level curve 306 merely based upon the fact that the set of offsets 324 within the N level curve representation 322 may now depend upon the updated N−1 level curve (e.g., an offset may be a distance along an offset vector staring along the updated N−1 level curve).

The system 300 may comprise a curve representation component 314. The curve representation component 314 may be configured to create a hierarchical multi-resolution representation 316 of a curve comprising one or more level curve representations associated with the curve (e.g., an N−1 level curve representation 318 representing the N−1 level curve 302, the N level curve representation 322 representing the N level curve 306, and N+1 level curve representation 326 representing an N+1 level curve not illustrated, etc.). For illustrative purposes, the N−1 level curve 302 is illustrated as a solid line, while the N level curve 306 is illustrated as a dashed line. In one example, the N−1 level curve 302 may represent a relatively lower resolution of the curve (e.g., a first resolution showing minimal bends along the curve), while the N level curve 306 may represent a relatively higher resolution of the curve (e.g., a second resolution with additional bends along the curve that may be more representative of how the curve may appear at a higher resolution/detail).

In one example, the N−1 level curve 302 may comprise a first-level curve represented by one or more points along the N−1 level curve 302 (e.g., known point 304). The curve representation component 314 may be configured to create the N−1 level curve representation 318, which may comprise a set of points 320 representing the N−1 level curve 302 at a first resolution (e.g., a lowest resolution). In this way, the set of points 320 may be interpolated to construct/render the N−1 level curve 302.

The curve representation component 314 may be configured to create the N level curve representation 322 of the N level curve 306, which may comprise the set of offsets 324 representing the N level curve 306. That is, a first set of offset vectors (e.g., offset vector 308 from the known point 304 of the N−1 level curve 302 to the N level curve 306 along a normal vector) may be computed from points (e.g., known point 304 along the N−1 level curve 302) that are defined within the N−1 level curve representation 318 (e.g., within the set of points 320). A second set of offset vectors (e.g., offset vector 312 from inferred point 310 of the N−1 level curve 302 to the N level curve 306 along a normal vector) may be computed from inferred points (e.g., inferred point 310 along the N−1 level curve 302) along the N−1 level curve 302 (e.g., the set of points 320 may be interpolated to identify one or more inferred points, such that the set of points 320 and the inferred points represent a higher resolution associated with the N level curve 306). It may be appreciated that known points along the N−1 level curve 302 are illustrated as white circles (e.g., known point 304), while inferred points along the N−1 level curve 302 are illustrate as black circles (e.g., inferred point 310). The set of offsets 324 may be computed based upon at least some of the first set of offset vectors and/or at least some of the second set of offset vectors. The set of offsets 324 may comprise offsets representing distances from the N−1 level curve 302 to the N level curve 306 along offset vectors (e.g., a first offset may represent a distance from the known point 304 on the N−1 level curve 302 to the N-level curve 306 along the offset vector 308, a second offset may represent a distance from the inferred point 310 on the N−1 level curve 302 to the N level curve 306 along the offset vector 312). In this way, the curve representation component 314 may create the N level curve representation 322 representing the N level curve 306 as a set of offsets 324 from the N−1 level curve 302.

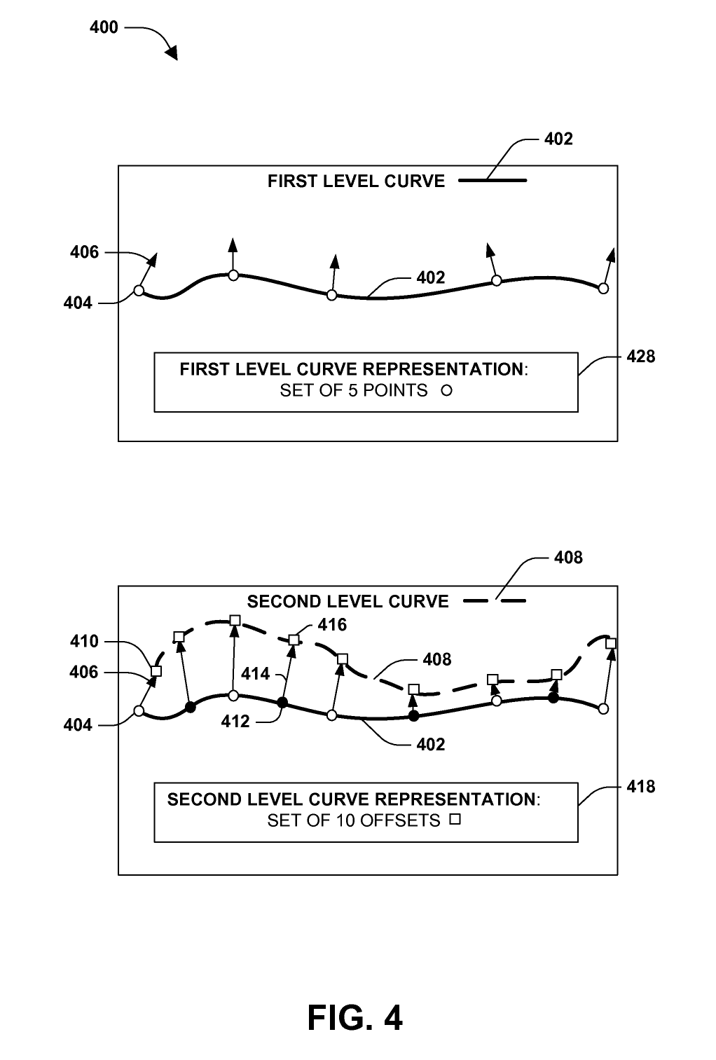

FIG. 4 illustrates an example 400 of a first-level curve 402 and a second-level curve 408. For illustrative purposes, the first-level curve 402 may be illustrated as a black line, while the second-level curve 408 may be illustrated by a dashed line. The first-level curve 402 may represent a relatively low resolution of a curve (e.g., a lowest resolution of a shoreline). A first-level curve representation 428 may comprise a set of points defining the first-level curve 402 (e.g., a set of 5 known points illustrated as white circles, such as known point 404). In this way, the first-level curve 402 may be constructed by interpolating the set of points within the first-level curve representation 428.

The second-level curve 408 may represent a relatively medium resolution of the curve (e.g., a relatively higher resolution of the shoreline in comparison with the first-level curve 402). A second-level curve representation 418 may comprise a set of offsets defining the second-level curve 408 (e.g., a set of 10 offsets illustrated as white squares, such as a first offset 410 and/or a second offset 416). The set of offsets may comprise offsets along offset vectors starting at known points along the first-level curve 402 that may be specified within the first-level curve representation 428 (e.g., first offset 410 may represent a distance along a first offset vector 406 starting at known point 404) and/or may comprise offsets along offset vectors starting at inferred points along the first-level curve 402 (e.g., second offset 416 may represent a distance along a second offset vector 414 starting at inferred point 412). For illustrative purposes, the known points may be illustrated as white circles, while the inferred points may be illustrated as black circles. Because the second-level curve 408 may represent a relatively higher resolution of the curve than the first-level curve 402, the inferred points may be used in addition to the known points in order to construct the second-level curve representation at the relatively higher resolution (e.g., the first-level curve 402 may correspond to a resolution of 5 known points, while the second-level curve 408 may correspond to a resolution of 10 offsets derived from offsets vectors starting at the 5 known points and the 5 inferred points along the first-level curve 402).

It may be appreciated that a variety of techniques may be used to identify the inferred points, and that any number of inferred points may be identified (e.g., the number of inferred points is not limited to the number of known points and/or a multiple, such as 2, of the number of known points). That is, the number of inferred points is not limited to being based upon the number of known points and/or is not limited to being uniformly distributed along a lower-level representation of the curve. For example, a first-level curve may comprise 20 known points. A first portion of a second-level curve may comprise a relatively large difference in curvature as compared to a corresponding first portion of the first-level curve, while a second portion of the second-level curve may comprise a relatively similar curvature as compared to a corresponding second portion of the first-level curve. Accordingly, a relatively high concentration of inferred points may be inferred along the first portion of the first-level curve because of the relatively large difference in curvature (e.g., 30 inferred points), while a relatively low concentration of inferred points may be inferred along the second portion of the first-level curve because of the relatively small difference in curvature (e.g., 4 inferred points). Data structures, such as a binary tree (e.g., a 1-D quad tree), may be used to store portions of respective level curves that may be used to infer points, for example.

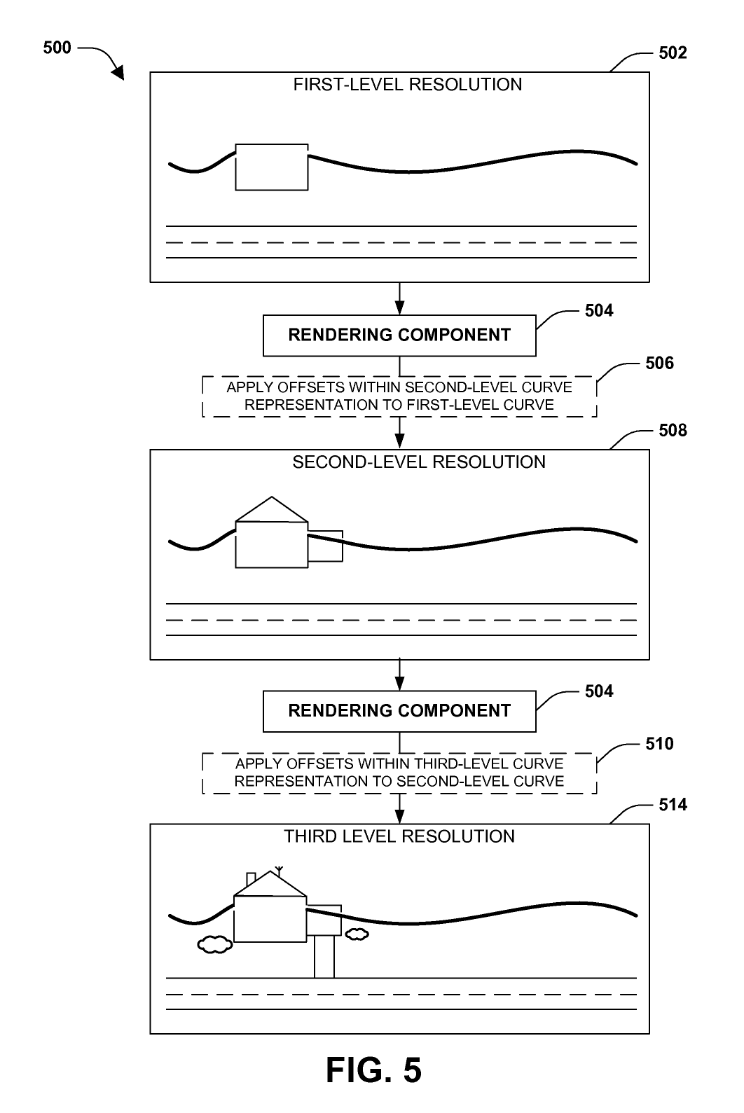

FIG. 5 illustrates an example 500 of rendering a curve based upon one or more level curves. In one example, a curve may correspond to a shoreline area. A first-level resolution 502 may correspond to a first-level curve represented by a first-level curve representation within a hierarchical multi-resolution representation of the curve. The first-level resolution 502 may comprise a shoreline, a rough depiction of a house, and a road. The first-level curve representation may comprise a set of points representing the first-level curve, which may be interpolated by a rendering component 504 to construct/render the first-level resolution 502.

In one example, the hierarchical multi-resolution representation may comprise one or more non-first-level curve representations (e.g., a second-level curve, a third-level curve, etc.). The rendering component 504 may be configured to render a second-level resolution 508 of the curve based upon the first-level curve representation and/or a second-level curve representation representing a second-level curve. The second-level curve may correspond to a relatively higher resolution depiction of the shoreline area than the first-level curve (e.g., a user may have zoomed into the second-level resolution 508 using a map editing application, and may have added a roof and a garage, which may have been stored as offsets within the second-level curve representation). The second-level curve representation may comprise a set of offsets (e.g., distances along offset vectors from the first-level curve to the second-level curve) that may be used to construct/render the second-level curve within the second-level resolution 508. For example, the rendering component 504 may interpolate the set of points within the first-level curve representation to render the first-level curve. The rendering component 504 may apply 506 the offsets within the second-level curve representation to the first-level curve, and may interpolate between the offsets to render the second-level curve. In this way, the rendering component 504 may create the second-level resolution 508 of the curve.

The rendering component 504 may be configured to render a third-level resolution 514 based upon the first-level curve representation, the second-level curve representation, and/or a third-level curve representation. The third-level curve representation may represent a third-level curve corresponding to a relatively higher resolution depiction of the shoreline area than the first and second-level curve (e.g., a chimney, driveway, TV antenna, shrubs, etc.). The third-level curve representation may comprise a set of offsets (e.g., distances along offset vectors from the second-level curve to the third-level curve) that may be used to construct/render the third-level curve within the third-level resolution 514. For example, the rendering component 504 may interpolate the set of points within the first-level curve representation to render the first-level curve. The rendering component 504 may apply the offsets within the second-level curve representation to the first-level curve, and may interpolate between the offsets to render the second-level curve. The rendering component 504 may apply 510 the offsets within the third-level curve representation to the second-level curve, and may interpolate between the offsets to render the third-level curve. In this way, the rendering component 504 may create the third-level resolution 514 of the curve.

In one example, one or more filtering techniques may be selectively applied to a particular resolution of the curve. For example, a smoothing filter technique may be applied to the second-level curve within the third-level resolution (e.g., but not the first-level curve and/or the third-level curve). In this way, various filters may be selectively applied to particular level curves.

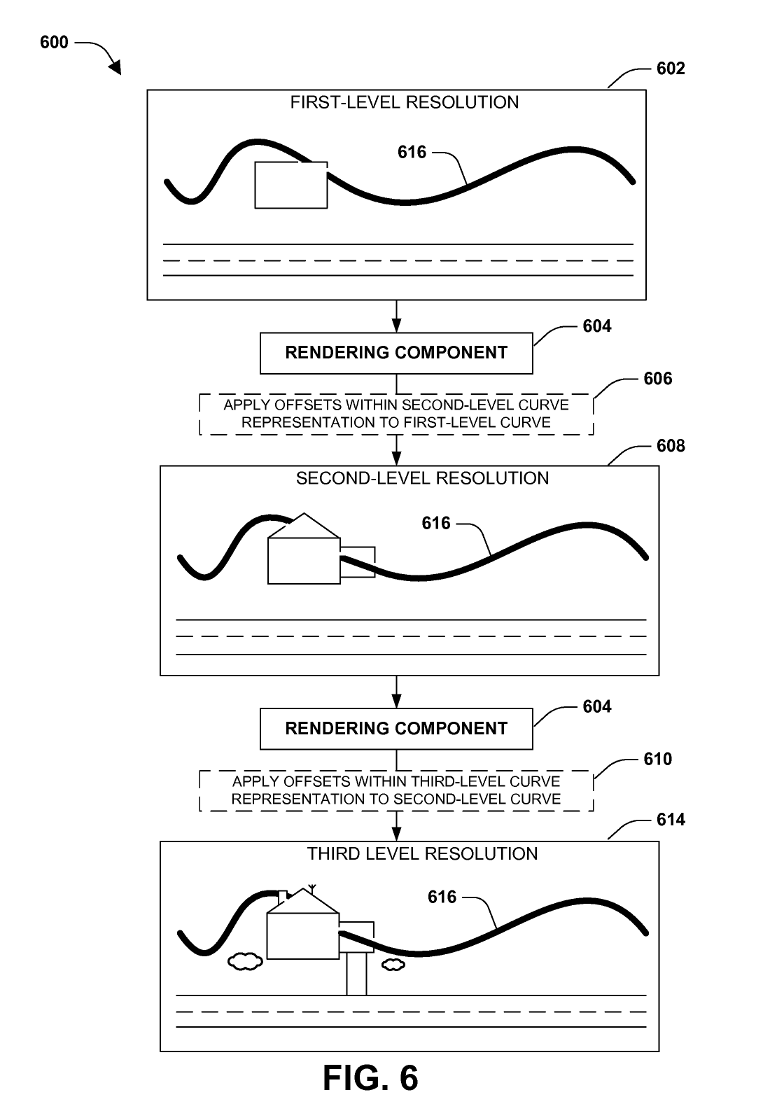

FIG. 6 illustrates an example 600 of rendering a curve based upon an updated first-level curve. In one example, a curve may correspond to a shoreline area. A first-level resolution 602 may correspond to an updated first-level curve represented by an updated first-level curve representation within a hierarchical multi-resolution representation of the curve. The first-level resolution 602 may comprise a shoreline, a rough depiction of a house, and a road. In one example, a first-level curve may have been updated with modifications to the shoreline to create a modified shoreline 616 depicted within the updated first-level curve (e.g., a user may have zoomed into a first-level resolution 502 of FIG. 5 to redraw the shoreline as illustrated in the first-level resolution 602). Based upon the modification, the first-level curve representation may have been updated with the modifications to create the updated first-level curve representation. For example, a set of points within the first-level curve representation may have been updated to create an updated set of points corresponding to the modified shoreline 616. A rendering component 604 may be configured to interpolate the updated set of points to construct/render the first-level resolution 602.

In one example, the hierarchical multi-resolution representation may comprise one or more non-first-level curve representations (e.g., a second-level curve, a third-level curve, etc.). Because the level curve representations may correspond to separate level curves, the modification to the first-level curve representation (e.g., the update to the shoreline) may not overwrite other level curve representations (e.g., the second-level curve may still correspond to a garage and roof for the house; the third-level curve may still correspond to a chimney, a TV antenna, shrubs, and driveway for the house; etc.). However, the level curve representations of the level curves may comprise offsets that depend upon other level curves (e.g., a second-level curve representation may comprise a set of offsets that may now be applied to the updated first-level curve). Thus, the modifications to the shoreline of the first-level curve may be “propagated” to other level curves in that offsets of the other level curves may now directly and/or indirectly depend upon the updated level curve. For example, the roof and garage of the second-level curve may be offset from the modified shoreline 616 and the house of the first-level curve, thus resulting in the roof and garage being placed in a similar location relative to the modified shoreline 616 and house.

The rendering component 604 may be configured to render a second-level resolution 608 of the curve based upon the updated first-level curve representation and/or the second-level curve representation. The second-level curve may correspond to a relatively higher resolution depiction of the shoreline area than the updated first-level curve. The second-level curve representation may comprise a set of offsets (e.g., distances along offset vectors from the updated first-level curve to the second-level curve) that may be used to construct/render the second-level curve within the second-level resolution 608. For example, the rendering component 604 may interpolate the updated set of points within the updated first-level curve representation to render the updated first-level curve. The rendering component 604 may apply 606 the offsets within the second-level curve representation to the updated first-level curve, and may interpolate between the offsets to render the second-level curve. In this way, the rendering component 604 may create the second-level resolution 608 of the curve.

The rendering component 604 may be configured to render a third-level resolution 614 based upon the updated first-level curve representation, the second-level curve representation, and/or a third-level curve representation. The third-level curve representation may represent a third-level curve corresponding to a relatively higher resolution depiction of the shoreline area than the updated first-level curve and the second-level curve. The third-level curve representation may comprise a set of offsets (e.g., distances along offset vectors from the second-level curve to the third-level curve) that may be used to construct/render the third-level curve within the third-level resolution 614. For example, the rendering component 604 may interpolate the updated set of points within the updated first-level curve representation to render the updated first-level curve. The rendering component 604 may apply the offsets within the second-level curve representation to the updated first-level curve, and may interpolate between the offsets to render the second-level curve. The rendering component 604 may apply 610 the offsets within the third-level curve representation to the second-level curve, and may interpolate between the offsets to render the third-level curve. In this way, the rendering component 604 may create the third-level resolution 614 of the curve.

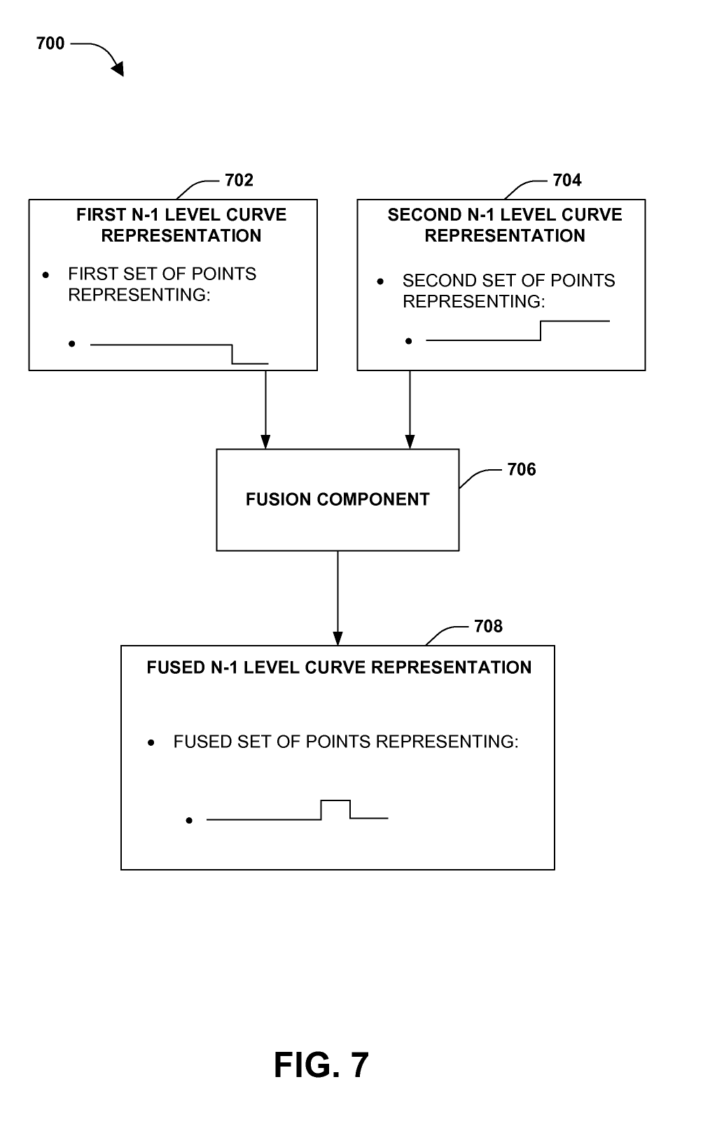

FIG. 7 illustrates an example 700 of fusing a first N−1 level curve representation 702 and a second N−1 level curve representation 704. The first N−1 level curve representation 702 may represent a first instance of a first-level curve at a first resolution. For example, the first N−1 level curve representation 702 may comprise a first set of points representing a straight horizontal line that (moving from left to right) drops down towards the last fourth of the line (e.g., the first N−1 level curve may have been drawn on an online map by a first user at a relatively low resolution). The second N−1 level curve representation 704 may represent a second instance of the first-level curve at the first resolution. For example, the second N−1 level curve representation 704 may comprise a second set of points representing a straight horizontal line that (moving from left to right) jumps up towards the last third of the line (e.g., the second N−1 level curve may have been drawn on the online map by a second user at the relatively low resolution).

It may be advantageous to fuse together the first N−1 level curve representation by the first user with the second N−1 level curve representation by the second user (e.g., the first user and the second user may have been contemporaneously drawing on the online map through a map editing website from two separate computers). Accordingly, a fusion component 706 may be configured to fuse the first N−1 level curve representation and the second N−1 level curve representation to create a fused N−1 level curve representation 708. For example, the fusion component 706 may create a fused set of points based upon averaging (e.g., a weighted average based upon one or more factors, such as reliability of a user, etc.) the first set of points and the second set of points. In this way, the fused N−1 level curve representation 708 may comprise the fused set of points representing a fused N−1 level curve comprising a straight horizontal line with a square within the last third of the line (moving from left to right). In one example, a first set of offset vectors associated with the first N−1 level curve may be reconciled with a second set of offset vectors associated with the second N−1 level curve to create a fused set of offset vectors for the fused N−1 level curve. The fused set of points may be associated with the fused set of offset vectors for the fused N−1 level curve.

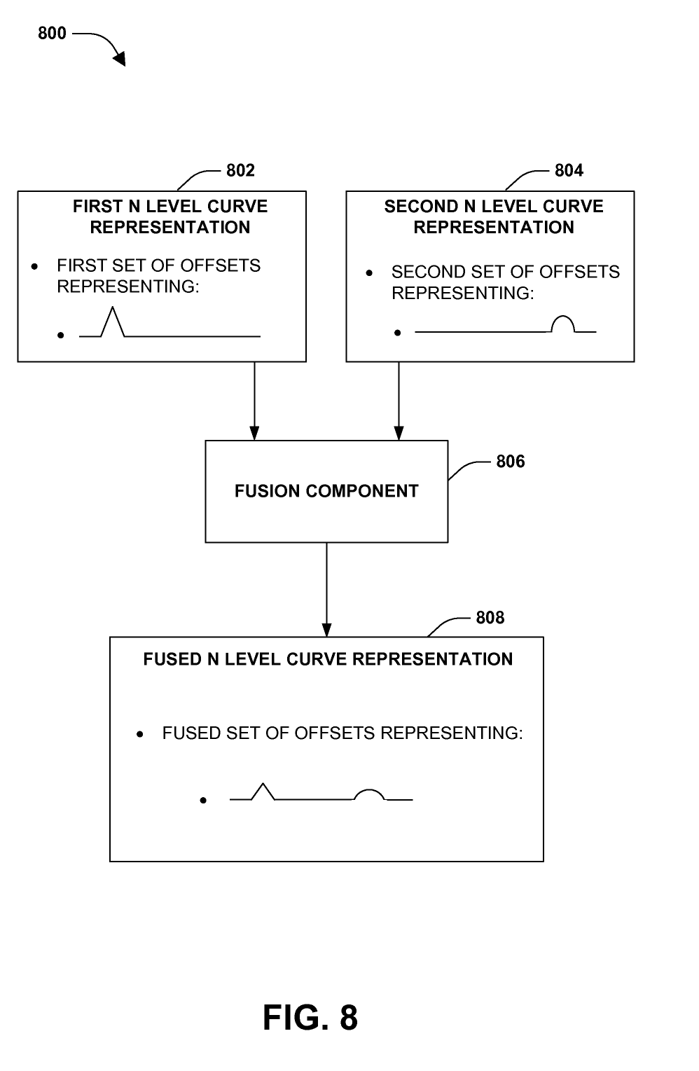

FIG. 8 illustrates an example 800 of fusing a first N level curve representation 802 and a second N level curve representation 804. The first N level curve representation 802 may represent a first instance of a second-level curve at a second resolution (e.g., compared to a first-level curve at a first resolution as illustrated within FIG. 7). For example, the first N level curve representation 802 may comprise a first set of offsets representing a straight horizontal line with a triangle near the start of the line (moving from left to right) (e.g., the first N level curve may have been drawn on an online map by a first user at a relatively medium resolution). The second N level curve representation 804 may represent a second instance of the second-level curve at the second resolution. For example, the second N level curve representation 804 may comprise a second set of offsets representing a straight horizontal line with a semi-circle near the end of the line (moving from left to right) (e.g., the second N level curve may have been drawn on the online map by a second user at the relatively medium resolution).

It may be advantageous to fuse together the first N level curve representation by the first user with the second N level curve representation by the second user (e.g., the first user and the second user may have been contemporaneously drawing on the online map through a map editing website from two separate computers). Accordingly, a fusion component 806 may be configured to fuse the first N level curve representation and the second N level curve representation to create a fused N level curve representation 808. For example, the fusion component 806 may create a fused set of offsets based upon averaging (e.g., a weighted average based upon one or more factors, such as reliability of a user, etc.) the first set of offsets and the second set of offsets. In this way, the fused N level curve representation 808 may comprise the fused set of offsets representing a fused N level curve comprising a straight horizontal line with a smaller/shorter triangle near the start (e.g., resulting from averaging a straight portion of the second-level curve with the triangle of the first-level curve) and a smaller/shorter semi-circle near the end of the line (e.g., resulting from averaging a straight portion of the first-level curve with the semi-circle of the second-level curve) (moving from left to right). In one example, a first set of offset vectors associated with the first N level curve may be reconciled with a second set of offset vectors associated with the second N level curve to create a fused set of offset vectors for the fused N level curve. The fused set of offsets may be associated with the fused set of offset vectors for the fused N level curve.

FIG. 9 illustrates an example 900 of updating a first-level curve representation based upon a modification to a first-level curve 904. A curve may be represented by one or more level curves corresponding to various resolutions of the curve. The first-level curve 904 may correspond to a relatively low resolution of the curve (e.g., a line with two relatively regular curves). The first-level curve 904 may be represented by the first-level curve representation comprising a set of points defining the first-level curve 904. A second-level curve 906 may correspond to a relatively medium resolution of the curve (e.g., a line with four relatively irregular curves). The second-level curve 906 may be represented by a second-level curve representation comprising a set of offsets (e.g., distances along offset vectors starting from the first-level curve 904 to the second-level curve 906) defining the second-level curve 906. The set of offsets may be dependent upon the first-level curve 904 in that the offsets are offsets along offset vectors starting from (known and/or interpolated) points along the first-level curve 904. In this way, modifications to the first-level curve 904 may be propagated to the second-level curve 906 by virtue of the offsets being dependent upon the first-level curve 904.

In one example, the first-level curve 904 and the second-level curve 906 may be illustrated within a second-level resolution 902. The first-level curve 904 may be modified as illustrated by modified first-level curve 914 within the modified second-level resolution 910. For example, a second half of the first-level curve 904 (e.g., as illustrated within the dashed box 916 within the second-level resolution 902 and the modified second-level resolution 910) may have been compressed and rotated clockwise at point 912. Accordingly, the first-level curve representation representing the first-level curve 904 may be updated 908 to create an updated first-level curve representation representing the modified first-level curve 914 (e.g., the set of points defining the first-level curve 904 may be updated to create an updated set of points). In one example, the second-level curve representation representing the second-level curve 906 may be unmodified (e.g., the set of offsets within the second-level curve representation may remain unmodified). However, the set of offsets within the second-level curve representation may now depend upon the modified first-level curve 914 as represented by the updated first-level curve representation. Thus, the second-level curve 906 may be illustrated/rendered within the modified second-level resolution 910 based upon applying the set of offsets within the second-level curve representation to the modified first-level curve 914.

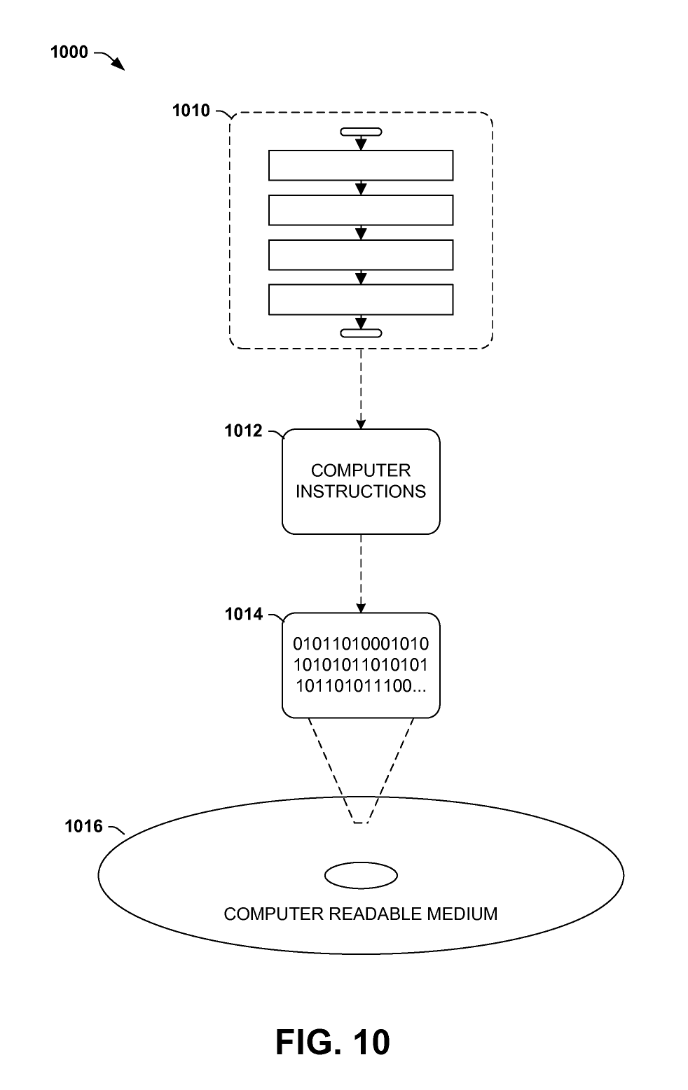

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1016 (e.g., a CD-R, DVD-R, or a platter of a hard disk drive), on which is encoded computer-readable data 1014. This computer-readable data 1014 in turn comprises a set of computer instructions 1012 configured to operate according to one or more of the principles set forth herein. In one such embodiment 1000, the processor-executable computer instructions 1012 may be configured to perform a method 1010, such as at least some of the exemplary method 100 of FIG. 1 and/or at least some of exemplary method 200 of FIG. 2, for example. In another such embodiment, the processor-executable instructions 1012 may be configured to implement a system, such as at least some of the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

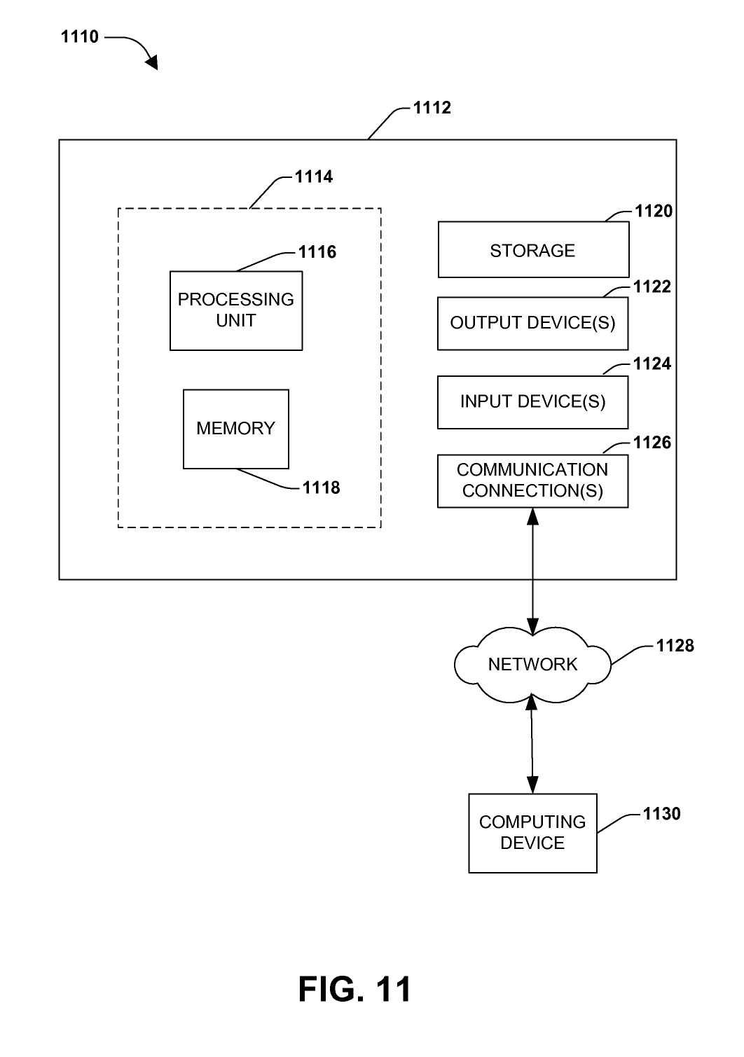

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 13114), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for representing an N level curve from an N−1 level curve, comprising:
computing a set of offset vectors from an N−1 level curve to an N level curve; and
creating an N level curve representation comprising a set of offsets representing the N level curve, an offset comprising a distance along an offset vector from the N−1 level curve to the N level curve.

2. The method of claim 1, the N−1 level curve representing a first resolution of a curve and the N level curve representing a second resolution of the curve, the second resolution higher than the first resolution.

3. The method of claim 2, comprising:
updating an N−1 level curve representation of the N−1 level curve based upon a modification to the N−1 level curve at the first resolution, the set of offsets within the N level curve representation dependent upon the updated N−1 level curve representation based upon the updating.

4. The method of claim 1, comprising:
creating a hierarchical multi-resolution representation of a curve comprising one or more level curve representations, a level curve representation associated with a resolution of the curve, the creating comprising:
representing a first-level curve as a first-level curve representation comprising a set of points; and
representing a non-first-level curve as a non-first-level curve representation comprising a set of offset vectors.

5. The method of claim 1, the computing a set of offset vectors comprising:
computing a first set of normal vectors from known points representing the N−1 level curve that are defined within an N−1 level curve representation, the N−1 level curve associated with a base resolution of a curve;
computing a second set of normal vectors from inferred points along the N−1 level curve; and
computing the set of offset vectors based upon at least one of:
at least some of the first set of normal vectors; and
at least some of the second set of normal vectors.

6. The method of claim 1, the computing a set of offset vectors comprising:
computing a first set of normal vectors from known positions along the N−1 level curve translated from offsets representing the N−1 level curve that are defined within an N−1 level curve representation, the N−1 level curve associated with a non-base resolution of a curve;
computing a second set of normal vectors from inferred positions along the N−1 level curve translated from offsets representing the N−1 level curve that are defined within the N−1 level curve representation; and
computing the set of offset vectors based upon at least one of:
at least some of the first set of normal vectors; and
at least some of the second set of normal vectors.

7. The method of claim 1, comprising:
representing an N+1 level curve comprising:
computing a second set of offset vectors from the N level curve to the N+1 level curve based upon at least one of:
known positions along the N level curve translated from the set of offsets within the N level curve representation, and
inferred positions along the N level curve translated from the set of offsets within the N level curve representation; and
creating an N+1 level curve representation comprising a second set of offsets representing the N+1 level curve, an offset within the second set of offsets comprising a distance along an offset vector within the second set of offset vectors from the N level curve to the N+1 level curve.

8. The method of claim 1, comprising:
fusing a first hierarchical multi-resolution representation of a curve and a second hierarchical multi-resolution representation of the curve, the fusing comprising:
averaging a first set of offsets within a first N level curve representation of the first hierarchical multi-resolution representation with a second set of offsets within a second N level curve representation of the second hierarchical multi-resolution representation to create a fused N level curve representation of a fused N level curve comprising a fused set of offsets; and
reconciling a first set of offset vectors associated with the first N level curve and a second set of offset vectors associated with the second N level curve to create a fused set of offset vectors for the fused N level curve, the fused set of offsets associated with the fused set of offset vectors for the fused N level curve.

9. The method of claim 8, the fusing comprising:
averaging a first set of points within a first N−1 level curve representation of the first hierarchical multi-resolution representation with a second set of points within a second N−1 level curve representation of the second hierarchical multi-resolution representation to create a fused N−1 level curve representation of a fused N−1 level curve comprising a fused set of points, the fused N level curve representation dependent upon the fused N−1 level curve representation; and
reconciling a first set of offset vectors associated with the first N−1 level curve and a second set of offset vectors associated with the second N−1 level curve to create a fused set of offset vectors for the fused N−1 level curve, the fused set of points associated with the fused set of offset vectors for the fused N−1 level curve.

10. The method of claim 8, the fusing comprising:
averaging a first set of offsets within a first N−1 level curve representation of the first hierarchical multi-resolution representation with a second set of offsets within a second N−1 level curve representation of the second hierarchical multi-resolution representation to create a fused N−1 level curve representation of a fused N−1 level curve comprising a second fused set of offsets, the fused N level curve representation dependent upon the fused N−1 level curve representation.

11. The method of claim 4, comprising:
rendering the curve utilizing one or more level curves within the hierarchical multi-resolution representation of the curve, the rendering comprising selecting the one or more level curves based upon a rendering resolution at which the curve is to be rendered.

12. The method of claim 1, comprising:
rendering the N level curve based upon applying the set of offsets to an N−1 level representation of the N−1 level curve.

13. The method of claim 1, the N level curve and the N−1 level curve corresponding to a curve associated with an online map editing service.

14. The method of claim 1, comprising:
applying a filter to the N level curve based upon executing a one-dimensional filtering technique upon the set of offsets within the N level curve representation without affecting the N−1 level curve.

15. A system for representing an N level curve from an N−1 level curve, comprising:
a curve representation component configured to:
compute a set of offset vectors from an N−1 level curve to an N level curve; and
create an N level curve representation comprising a set of offsets representing the N level curve, an offset comprising a distance along an offset vector from the N−1 level curve to the N level curve.

16. The system of claim 15, comprising:
a fusion component configured to:
fuse a first N level curve representation and a second N level curve representation, the fusing comprising:
averaging a first set of offsets within the first N level curve representation with a second set of offsets within the second N level curve representation to create a fused N level curve representation of a fused N level curve comprising a fused set of offsets; and
reconciling a first set of offset vectors associated with the first N level curve and a second set of offset vectors associated with the second N level curve to create a fused set of offset vectors for the fused N level curve, the fused set of offsets associated with the fused set of offset vectors for the fused N level curve.

17. The system of claim 15, comprising:
a rendering component configured to:
render the N level curve based upon applying the set of offsets to an N−1 level representation of the N−1 level curve.

18. The system of claim 15, the curve representation component configured to:
compute a first set of normal vectors from known points representing the N−1 level curve that are defined within an N−1 level curve representation, the N−1 level curve associated with a base resolution of a curve;
compute a second set of normal vectors from inferred points along the N−1 level curve; and
compute the set of offset vectors based upon at least one of:
at least some of the first set of normal vectors; and
at least some of the second set of normal vectors.

19. The system of claim 15, the curve representation component configured to:
compute a first set of normal vectors from known positions along the N−1 level curve translated from offsets representing the N−1 level curve that are defined within an N−1 level curve representation, the N−1 level curve associated with a non-base resolution of a curve;
compute a second set of normal vectors from inferred positions along the N−1 level curve translated from offsets that are defined within the N−1 level curve representation; and
compute the set of offset vectors based upon at least one of:
at least some of the first set of normal vectors; and
at least some of the second set of normal vectors.

20. A method for creating a hierarchical multi-resolution representation of a curve, comprising:
representing a first-level curve as a first-level curve representation within a hierarchical multi-resolution representation of a curve, the first-level curve representation comprising a set of points defining the first-level curve; and
for respective non-first-level curves:
representing a non-first-level curve as a non-first-level curve representation within the hierarchical multi-resolution representation of the curve, the non-first-level curve comprising a set of offsets dependent upon a lower-level curve, an offset comprising a distance along an offset vector from the lower-level curve to the non-first-level curve.
